(19) United States
(12) Patent Application Publication
(10) Pub. No.: US 2016/0253606 A1
(43) Pub. Date: Sep. 1, 2016

(54) Business Process Crowd Sourcing with Dynamic Group Discovery and Social Push Communications

(71) Applicant: Rulesware, LLC, Schaumbrg, IL (US)

(72) Inventors: Jon Pellant, Englewwod, FL (US); Pedro Miguel Muller, La Libertad (SV); Rodolfo Anibal Hernandez, San Salvador (SV)

(73) Assignee: Rulesware, LLC, Schaumburg, IL (US)

(21) Appl. No.: 15/002,321

(22) Filed: Jan. 20, 2016

Related U.S. Application Data
(60) Provisional application No. 62/121,718, filed on Feb. 27, 2015.

(51) Int. Cl. G06Q 10/06; G06Q 50/00

(52) U.S. Cl. CPC G06Q 10/0633; G06Q 50/01

(57) ABSTRACT

Systems and methods can support crowd-sourcing business process specifications within a process discovery system. A proposed process may be received from a process owner. The initial process may be published to one or more process participants. Isolation layers can be established comprising working copies of the initial process. Each working copy may be associated with one or more of the process participants. Social activity may be received from the participants. This activity may include modifications, markups, or comments to the working copies of the process. One or more relevant social groups of participants may be discovered. Process elements associated with increased levels of social activity may be indicated using heat maps. Notifications of process events may be pushed to participants. The process owner may selectively merge process modifications from the participants into a crowd-sourced business process specification, which can inform a development team implementing the business process.

### RELATED APPLICATION

This application claims priority to U.S. Provisional Patent Application No. 62/121,718, filed Feb. 27, 2015 and entitled “Process Crowd Sourcing to Leverage Relevant Group Discovery.” The complete disclosure of the above-identified priority application is hereby fully incorporated herein by reference.

### BACKGROUND

Teams of subject experts are generally responsible for defining or modifying business processes. For example, a subject-matter expert may be assigned to work with process automation developers in order to define processes or engage in process improvement initiatives. Efforts of such subject-matter experts often bring about process change that is not vetted through the community of stakeholders. This generally results in sub-optimal changes or changes that are considered out of date by the stakeholder majority. Unfortunately, properly determining detained process change needs is generally quite time consuming and may lack majority participation from the stakeholders. Also, it is generally challenging to get proposed process changes reviewed by relevant stakeholders. In fact, process change implementation teams generally do not even know the relevant community of stakeholders. With such complications usually not being unearthed until well into the deployment of process change, corrections generally add expensive rework and delays to the process change initiative.

Accordingly, there is a need in the art for technology operable to improve business process implementation or process change through automated identification of relevant stakeholders among a community of participants. There is a further need in the art for technology to automate efficient vetting of proposed new business processes or process changes through the identified participants to obtain timely feedback and buy-in.

### SUMMARY

In certain example embodiments described herein, methods and systems can support crowd-sourcing business process specifications within a process discovery system. A proposed process may be received from a process owner. The initial process may be published to one or more process participants. Isolation layers can be established comprising working copies of the initial process. Each working copy may be associated with one or more of the process participants. Social activity may be received from the participants. This activity may include modifications, markups, or comments to the working copies of the process. One or more relevant social groups of participants may be discovered. Process elements associated with increased levels of social activity may be indicated using heat maps. Notifications of process events may be pushed to participants. The process owner may selectively merge process modifications from the participants into a crowd-sourced business process specification. The specification may be used to inform a development team implementing the business process.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a collaborative business process group discovery environment in accordance with one or more embodiments presented herein.

FIG. 2 is a user interface diagram depicting a dashboard for a process participant of a collaborative group process discovery in accordance with one or more embodiments presented herein.

FIG. 3 is a user interface diagram depicting a process history and heat map in accordance with one or more embodiments presented herein.

FIG. 4 is a user interface diagram depicting process swim lanes in a collaborative group process discovery in accordance with one or more embodiments presented herein.

FIG. 5 is a flow diagram depicting communications within a collaborative group process discovery scenario in accordance with one or more embodiments presented herein.

FIG. 6 is a block flow diagram depicting a method for efficient social collaboration on business process development in accordance with one or more embodiments presented herein.

FIG. 7 is a block diagram depicting a computing machine and a module in accordance with one or more embodiments presented herein.

### DETAILED DESCRIPTION OF EXAMPLE EMBODIMENTS

### Overview

The technology presented herein can support social collaboration feedback on business process development. The technology can, furthermore, leverage relevant group discovery from process crowd sourcing. Collaborative process group discovery technology can provide dynamic heat maps illustrating social activity within discovery, design, and implementations of business processes. The technology can also provide for social pushing, social layering, crowd-sourced process discovery, and autonomous social relevant group discovery. A user, such as a process owner, may be provided with a dynamically evolving strategic overview of events or activities based on user engagement to expose insights as to where a process stands. The crowd sourcing process discovery tool can leverage relevant group discovery during process development and deployment. The collaborative group process discovery system can generate dynamic process heat maps that provide a constantly updating, visual, and intuitive mechanism to bring participant social interaction into the definition and refinement of business processes. Dynamic social group discovery can autonomously identify relevant groups based on user behavior or area of interests. Crowd-sourced layering of different process changes can support separate layers for social groups to share designs and expertise with one another.

The functionality of the various example embodiments will be explained in more detail in the following description, read in conjunction with the figures illustrating the program flow. Turning now to the drawings, in which like numerals indicate like (but not necessarily identical) elements throughout the figures, example embodiments are described in detail.

### Example System Architectures

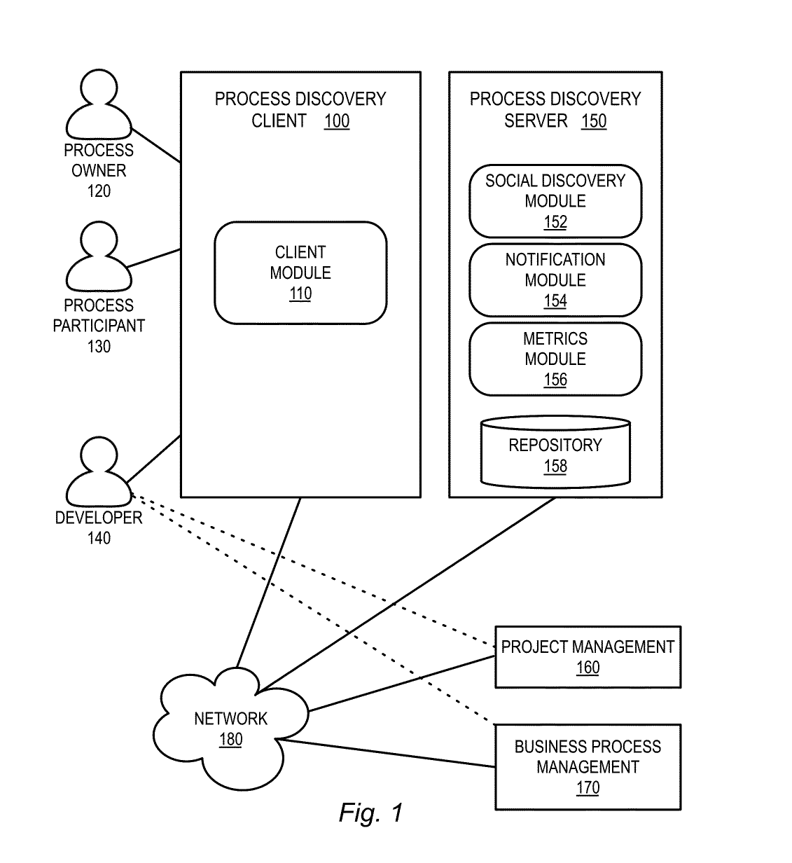

FIG. 1 is a block diagram depicting a collaborative business process group discovery environment in accordance with one or more embodiments presented herein. Users, such as one or more process owners 120, one or more process participants 130, and one or more developers 140 can access a process discovery client 100. The process discovery client 100 may operate in association with one or more client modules 110. The process discovery client 100 may interface with a process discovery server 150 via a network 180. The process discovery server 150 may operate in association with one or more modules such as a social discovery module 152, a notification module 154, and a metrics module 156. The process discovery server 150 may also operate in association with a data repository 158. The various users, the process discovery client 100, and the process discovery server 150 may interface with other systems such a project management system 160 and a business process management system 170. These interfaces may be supported through the network 180.

The process discovery client 100 can support interfacing for users such as one or more process owners 120, one or more process participants 130, and one or more developers 140. The client module 110 may include executable instructions in the form of software or one or more software applications. The client module 110 may also include executable instructions, scripts, or markup language associated with a browser. Such a browser may support the user interfaces of the process discovery client 100. The client module 110 may further include modules for notification, process modeling, and social events. It should be appreciated that the process discovery server 150 may operate as one or more cloud services.

The social discovery module 152 can receive user events. User events may include creation of a new process, comments on an existing process, updating elements of a process, or logging access information. The social discovery module 152 may support one or more of social group membership mechanisms, social layering mechanisms, collaboration mechanisms, and crowd sourced process discovery mechanisms.

The social discovery module 152 can also maintain a discovery database, an event history database, and a rules database. These databases may be associated with the data repository 158. The discovery database may include discoveries such as which process participants 130 are engaging with which aspects of which processes. The discovery database may also include discoveries such as which aspects of which processes are being actively commented, refined, or otherwise engaged. The discovery database may store measures of how actively the processes (and/or aspects thereof) are being engaged by the various users such as process participants 130. For example, the discovery database may store when a process, or aspect thereof, is being hotly contested among the process participants 130. Such engagement may take place within the context of crowd sourced business process design, redesign, or refinement.

The event history database can support event logging and may maintain comments and modifications associated with the business process design or business process improvement. The rules database can support social discovery rule engine operations for determining patterns of social engagement by the process participants 130. For example, rules may be established for determining which process participants 130 are engaging with which type of business process proposals or design aspects.

The notification module 154 can offer process discovery to designated or determined process participants 130. The notification module 154 can also crowd source process components, features, feedback, refinement, and so forth. The notification module 154 can also communicate group push communications to designated or determined process participants 130. The notification module 154 can provide priority distribution and social push. The notification module 154 can leverage a rules engine and rules database. The rules database may be associated with the data repository 158. The rules engine may support determining the presence of a user and their preferred notification mechanism including but not limited to sounds, badges, alerts, alarms, emails, text messages, or instant messages.

The metrics module 156 can support generation of heat maps, tracking gamification elements, monitoring power users, and maintaining a metrics database. The metrics database may be associated with the data repository 158. The metrics module 156 can support gamification, for example by scoring process participants 130 to encourage social participation. The metrics module 156 can identify power users among the process participants 130 as high scoring or high participation individuals.

According to certain embodiments, the data repository 158 may store and maintain a discoveries repository datastore, an event history repository datastore, a business process repository datastore, a business rules repository datastore, and an update metrics datastore.

According to certain embodiments, the modules associated with the process discovery client 100 and the process discovery server 150 may include code or scripts associated with MEAN.js. These may also leverage MongoDB, Express.js, Angular.js, and Node.js. For example, process discovery server 150 may maintain data within a MongoDB associated with with Express.js and Node.js, while the process discovery client 100 may be associated with a browser supporting angular.js and d3.js. Although these specific technology stacks have been presented as examples, it should be appreciated that the technology presented herein may be realized using a variety of alternate and/or equivalent implementation modalities without departing from the spirit or scope of the present disclosure.

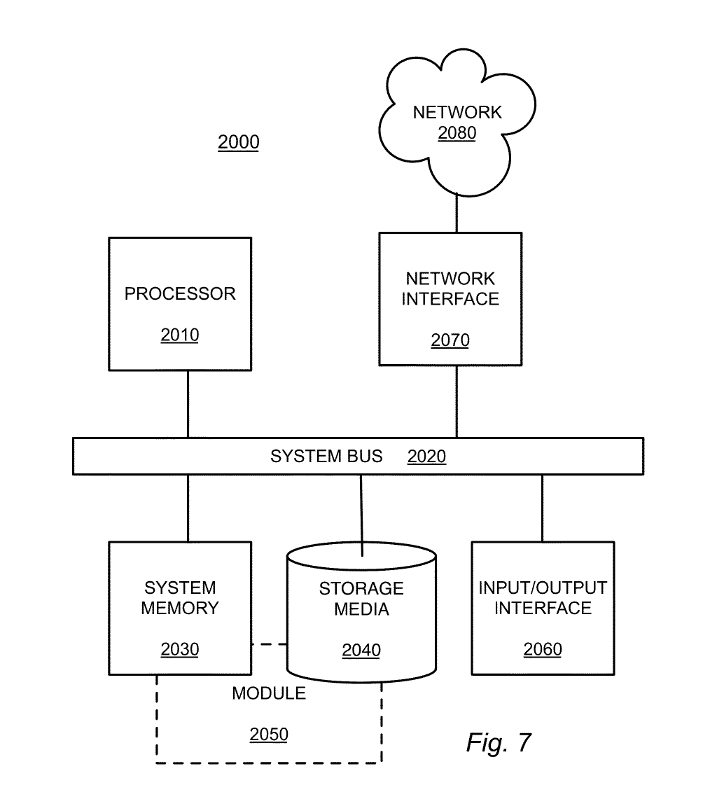

The process discovery client 100, process discovery server 150, or any other systems associated with the technology presented herein may be any type of computing machine such as, but not limited to, those discussed in more detail with respect to FIG. 7. Furthermore, any modules associated with any of these computing machines or any other modules (scripts, web content, software, firmware, or hardware) associated with the technology presented herein may by any of the modules discussed in more detail with respect to FIG. 7. The devices and computing machines discussed herein may communicate with one another as well as other computer machines or communication systems over one or more networks such as network 180. The network 180 may include any type of data or communications links or network technology including any of the network technology discussed with respect to FIG. 7.

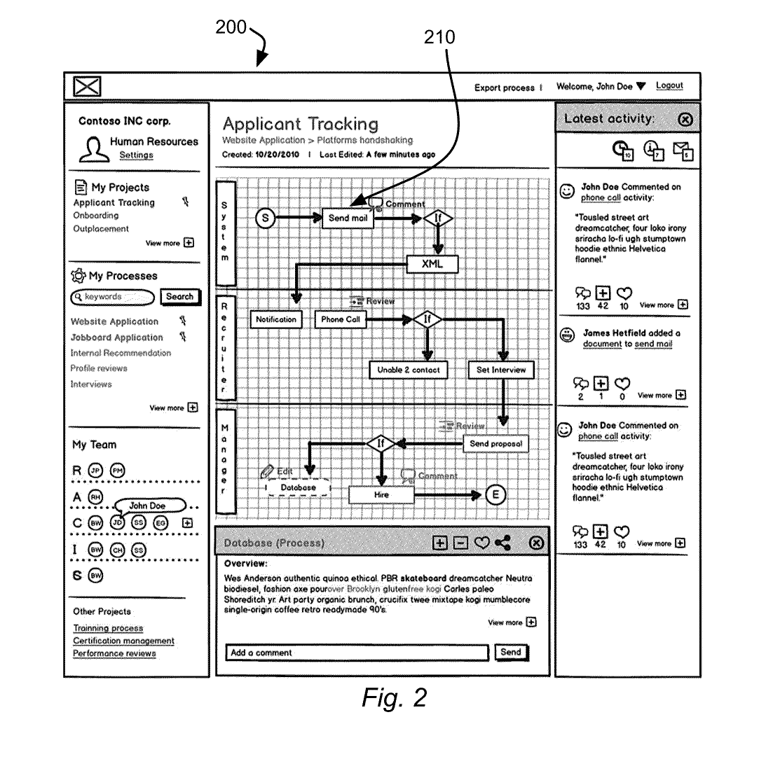

FIG. 2 is a user interface diagram depicting a dashboard 200 for a process participant 130 of a collaborative group process discovery in accordance with one or more embodiments presented herein. According to the illustrated embodiment, the dashboard 200 displays My Projects, My Processes, My Team, Other Projects, and a historical view of which process participant 130 (or other users) have acted upon the process associated with the active window.

The My Projects section may include a list of projects that the process participant 130 is authorized to access. These may be projects where that process participant 130 is a team member. The My Processes section can show the business processes that the process participant 130 is involved in as a participant, as a team member, or as a developer.

The My Team section can display other user's role on a team or project in this context. While the illustrated model for the My Team display leverages a template based on a RACIS model specifying individuals who are Responsible, Accountable, Consulted, Informed, and Supporting (RACIS), the model can be customized as needed. Furthermore, the My Team section may show the different roles of the process participants 130.

The Other projects section shows other processes a user might have interest in following based on the social relevance of the process as determined by the process discovery server 150.

Process elements within the dashboard 200 may be highlighted, color coded, tagged, animated, or otherwise annotated. For example, the send mail element 210 might be highlighted in red to indicate to the process participant 130 that there is a problem or negative feedback associated with this proposed process element or step. Such marking may be referred to as a heat map and can provide rapid visualization of process elements or steps that are in contention among the process participants 130. The heat map display may be represented by a style change that highlights its state as negative (for example, red), positive (for example, green) or another type of feedback (for example, blue). Various other examples or coloring or annotation may be used without departing from the spirit or scope of the technology presented herein.

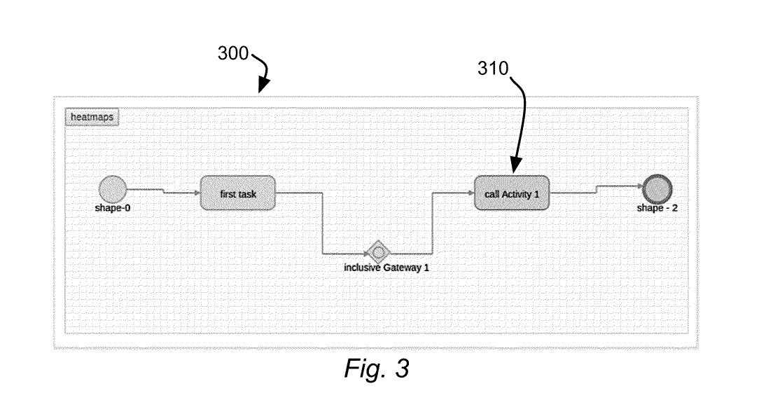

FIG. 3 is a user interface diagram depicting a process history and heat map 300 in accordance with one or more embodiments presented herein. The process includes an initial shape, a first task, an inclusive gateway, a call activity 310, and a shape target. According to an example scenario, a notification may be generated regarding the call activity 310. This may be show within the process heat map 300 by highlighting, coloring, flashing, animating, or otherwise annotating the call activity 310. According to various embodiments, the notification may cause the box associated with the call activity 310 to change styles such as size, animate with pulsing borders, pulsing element size, alternating colors, or other means of highlighting proportionally the relative importance of social involvement to the call activity 310 or elements associated therewith. Such social involvement may include commenting, ranking, rating, or providing an alternative process or elements.

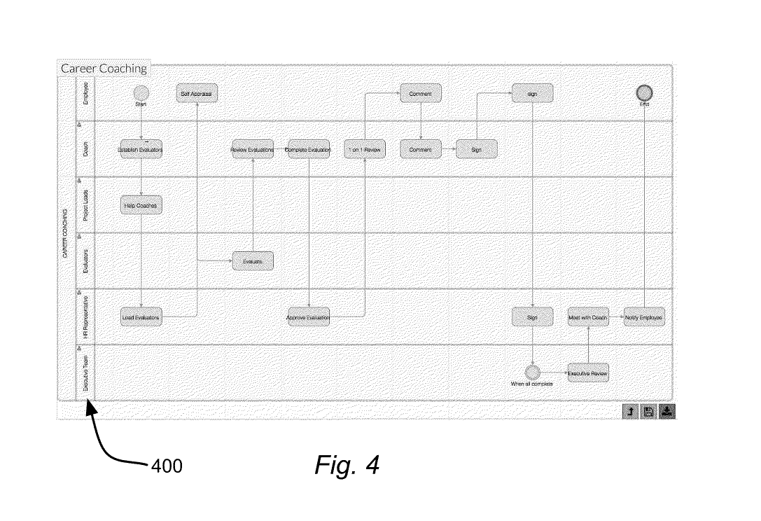

FIG. 4 is a user interface diagram depicting process swim lanes 400 in a collaborative group process discovery in accordance with one embodiment. Each swim lane 400 can identify and categorize members of the participant group who are involved in the execution and evaluation of the new process. The categories may be established according to particular roles or responsibilities associated with the process.

### Example Processes

According to methods and blocks described in the embodiments presented herein, and, in alternative embodiments, certain blocks can be performed in a different order, in parallel with one another, omitted entirely, and/or combined between different example methods, and/or certain additional blocks can be performed, without departing from the scope and spirit of the invention. Accordingly, such alternative embodiments are included in the invention described herein.

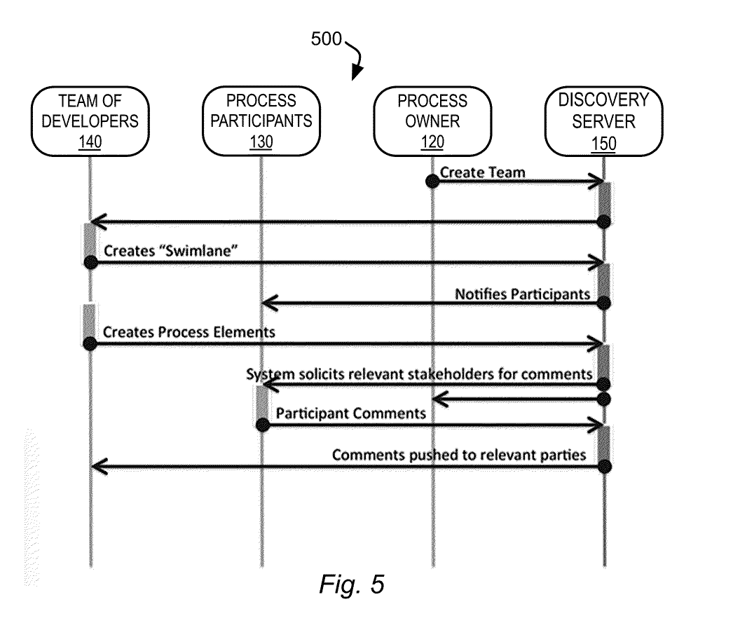

FIG. 5 is a flow diagram 500 depicting communications within a collaborative group process discovery scenario in accordance with one embodiment. The Social Discovery Module 152 can identify relevant events that should be pushed for commenting to interested parties. In the illustrated example, a process owner 120 can use the process discovery server 150 to create a new business process project and also create a project team of developers 140. The project developers 140 can start working on a new process. While editing the new process, the developer team 140 can create new swim lanes 400 on the system. According to certain embodiments, the swim lane 400 can identify members of the participant group who are involved in the execution and evaluation of the new process. The project team can create new process elements. Upon team creation of a process element, the process discovery server 150 can notify the members of the participant group that this action has occurred and encourage participants to comment on the activities. Since the process discovery server 150 has identified the participants and interested parties of this process, the additional elements are “pushed” to the interested parties for comment. According to certain embodiment, comments also passed out to interested parties as events. According to certain embodiments, a heat map for the process is created and shared to the team of developers 140.

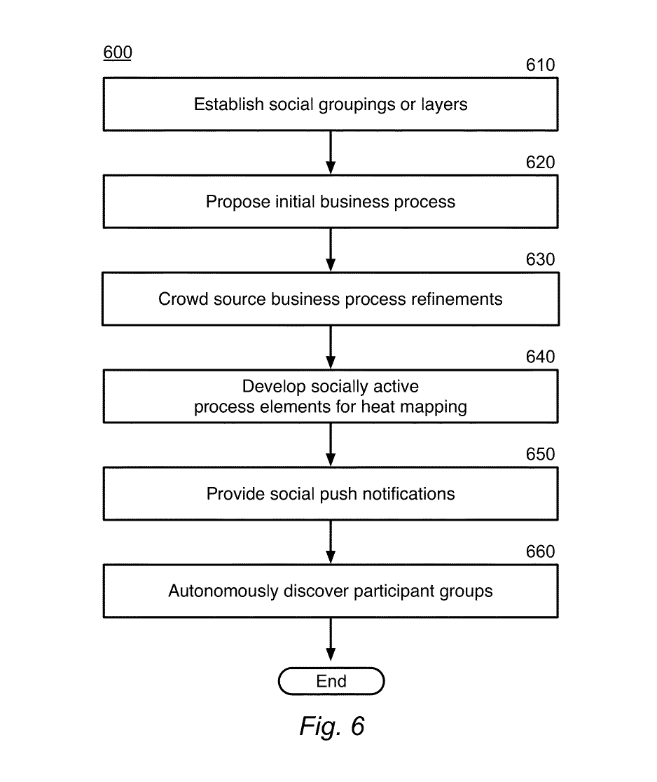

FIG. 6 is a block flow diagram depicting a method 600 for efficient social collaboration on business process development in accordance with one or more embodiments presented herein. In block 610, the process discovery server 150 can establish social groupings or layers. One or more social layers may be created for social groups to share designs and information with. Individuals may also have their own layer. Individual layers may be used for experimentation or scratch-work. Social layering may begin when the process owner 120, or an agent thereof, publishes an initial draft of the process. Once this publication has occurred, process participants 130, acting as groups or individuals, may attempt to modify or markup elements within the original process. Social layering configuration information may be referenced to verify that the process participant 130 has the appropriate access privileges to modify or markup the process. Once access privileges are verified, the process may be replicated to a new layer in the context of the requesting process participant 130. Here, the process participant 130 can work on their copy of the process without destroying the copy associated with the process owner 120.

In block 620, the process discovery server 150 can receive a proposed initial business process. The process owner 120, or an agent thereof, can publish an initial draft of the process. Once this publication has occurred, process participants 130 may create copies of the process for proposing modification or marking up with comments.

In block 630, the process discovery server 150 can crowd source business process refinements. Such crowd sourcing may comprise collaboration and communication functions. Process participants 130 wishing to contribute to process refinement may replicate the process to a new layer within their own context. The process participants 130 can modify their copy of the process as they wish, add comments, and otherwise contribute to their own draft version or the process. Such modification or markups may be saved in the context of the layer specific to the contributing process participants 130.

The revised process may be submitted or shared to the process owner 120 and/or other process participants 130. The process owner 120 may review the proposed revisions to the process. The process owner 120 can identify modification to be merged into their copy of the process. The process owner 120 may do so, for example, when they agree that the proposed modifications from the process participants 130 add value to the process. Also, other process participants 130 can review the newly submitted layers along with associated processes and/or suggestions. The process participants 130 can interact with the submissions, for example, by rating them. The process participants 130 can also copy any version of the process and submit additional edits thereby creating new layers and new suggestions to the original process associated with the process owner 120. The steps of creating a new layer, copying a process, modifying the copy of the process, submitting the modified copy, and evaluating the submitted copy may be repeated for any number of process participants 130 that wish to collaborate on the development or refinement of the process.

Utilizing crowd-sourced process discovery can enable process participants 130 to contribute logical next steps or user stories based on the aggregate knowledge and experience of the process participants 130 or crowd. Results of crowd queries and responses may be compiled to provide process owners 120 with details of the various crowd-sourced inputs. The process owner 120 can review alternative views as discovered by the process discovery server 150. Crowd-sourced process discovery can enable process participants 130 interested in a particular process to collaborate within the process in order to provide feedback and suggestions to the process owner 120. This can benefit the ultimate goal of improving the process.

Once the process owner 120 published or posts a process into the process discovery server 150, it may be available for review and collaboration by the various relevant process participants 130. The process participants 130 can view the layers of the process they are interested in. The process participants 130 guide and shape the process, or parts thereof, based on their own expertise and perspective regarding how the process may best suit its purpose.

The crowd can include the process owner 120, the development team 140, and various process participants 130. Feedback and suggestions collected from the crowd can be shared. Suggestions for changes and improvements can contribute to the process development and refinement resulting in an improved process. In addition to a higher quality process, crowd sourced process development can result in more knowledgeable process owners 120 and process participants 130. The various social layers can help to organize those knowledge collection, sharing, and process improvement. Each process participant 130 can work with a distinct layer, all of which may be separate from the layer containing the original process associated with the process owner 120. As process participants 130 work on a process, the process discovery server 150 can save any changes or comments into their respective unique layer. Once the layers are submitted, the process owner 120 can view the multiple layers to visualize, along with the original process, any changes and comments that were created by the process participants 130. The process owner 120 can compare and select crowd sourced suggestions for merging into the original process. Once collaboration with the process participants 130 has been completed, the process discovery server 150 will contain the original published process along with the customized, crowd-sourced versions. The process owner 129 can view a collection of variant processes and evaluate whether the suggested modifications should be added to the original process. Once the process owner 120 integrates the suggestions that have satisfied their evaluation criteria into the original process, a resultant crowd-sourced process can incorporate the collected knowledge and experience of the crowd.

In block 640, the process discovery server 150 can develop socially active process elements for heat mapping. The heat map 300 can display an overview of the most popular and/or contentious issues within the process. These issues may relate to suggested modifications, comments, agreements, or disagreements generated by each event or activity. As more and more process participants 130 modify or markup a particular element of the process, those elements may be indicated for high social activity within the heat map 300. The indicators can quickly inform process participants 130 as to which parts of the process are associated with a high level of discussion. The heat map 300 can be generated dynamically by the corresponding social activity and by the timing of that activity. For example, as time elapses after discussion on a particular element, the heap map 300 may be updated to become progressively “cooler” which will be visually represented by a range of colors and/or other stylistic changes to indicate that the issue is settling down.

The mechanisms for indication of high social activity may include rendering with different fonts (such as bolded, italic, or larger size), different colors (such as brighter, darker, highlighted, shadowed), different size outlines, different border thickness or style, blinking/flashing, other visual animation, or any other visual indicator to differentiate high levels of social activity from elements having normal or low social activity. The visual indicators on the heat map 300 can use multiple intensity levels to indicate various levels of social activity. For example, more active elements may display with faster flashing, brighter highlighting, larger size, and so forth. These levels may be scaled dynamically. In addition to use of dynamic scaling to indicate level of activity, the heat map 300 may also display visual descriptions of changes or events within a process. Change indicators may be based upon changes since the last time that the particular process participant 130 reviewed the process. According to certain embodiments, badges (with differing styles) may indicate a variety of events such as modification of an element, an element having multiple layers or versions, comments, alternatives, and/or newly added elements.

The dynamic heat maps 300 can provide a constantly updating, visual, and intuitive mechanism to link interaction and actions from the process participants 130 into the design and specification of the process. The heat maps 300 can provide visibility into where discussions are occurring, what stage/step/shape has priority, what completions are noteworthy to share, what is and is not urgent, what documents are needed, what relevant metrics should be gathered and shared, alternatives to the process flow, and if the design is acceptable. The project development team 140 may leverage information associated with the heat maps 300 to detect likely areas for process improvement and possibly to prioritize where to direct their efforts. The dynamic heat maps 300 can support detecting anomalies or special situations where the process needs to change. They can also support detecting tasks or activities that have not been well developed/implemented and may need special attention.

In block 650, the process discovery server 150 can provide social push notifications. Change notifications may be automatically sent from the process discovery server 150 to the process owner 120, the development team 140, and/or various process participants 130. The notification may be provided specifically to those users who are both relevant and interested. An intelligent notification cascade may be determined dynamically using rules. The rules may be variously provided by any of the users such as the process owner 120. The process discovery server 150 can detect when a process participant 130 makes a contribution to the process. Such a contribution may be a suggested modification, a new shape/step/element, a comment, an attached a document, or so forth. The process discovery server 150 can react by sending a notification about the contribution to relevant or interested parties, such as the process owner 120, the development team 140, and/or other process participants 130. Accordingly, users may remain informed about submitted contributions or changes to processes that they are interested in.

The social push mechanisms may by controlled through a notification cascade engine associated with the notification module 154. The notification cascade engine may leverage various templates configured and/or customized to send notifications in a cascade structure based on the association of a user with a particular process. The notification cascade may process a finite, but variable, number of notifications level. Accordingly, users can specify the notification levels based on certain rules that create a dynamic sequential notification order. The notification cascade can issue notifications for each appropriate user and provide the flexibility of configuration that is based, in part, on user desires or requirements. The notification cascade may be based, in part, on customizable time rules and/or content rules, which may or may not be separately and/or independently defined by each process participant 130 or other user. For example, in one embodiment, the user might initially designate in-app notification, which provides social push to a user while they are accessing the application. However, if the user does not access the application in a period of time determined by the cascade rules, (e.g., three business days) then a notification email containing the application notifications may be sent. If after another period of time determined by the cascade rules (e.g., six business days) the user does not consume the notifications in the app, a new notification may be pushed to the user. Repeated or escalated notification may use alternative connection mechanisms, such as SMS text messages, emails, telephone messages, and so forth. In one embodiment, a time rule may be established so that if the user exhibits a period of inactivity in the application (e.g., three weeks), a reminder notification may be issued and may use escalating communication channels. Similarly, in one embodiment, a content rule may indicate that whenever a condition is met, such as whenever “action is required,” a notification may be sent using one designated communication channel, such as an SMS message. However, the content rule might also designate use of a different communication channel, such as email, whenever another condition is met. Accordingly, each user may specify rules and an order of notification based on time or content. The rules may variously target multiple communication channels.

In block 660, the process discovery server 150 can autonomously discover participant groups. Autonomous social relevant group discovery can discover groups based on their similar behavior or area of interests with regard to social interactions with process design/refinement. Groups of users may be automatically defined based on their expertise and their areas of interests. The users within those groups can be notified to make contributions to processes related to those expertise or areas of interest. Previous process interactions associated with a process participant 130 may be recognized to associate the process participant 130 with one or more groups containing similar process participants 130. For example, process participants 130 with similar interests or rating behaviors may be organized into the same social groupings. For example, a user working within a particular swim lane 400 of a process X may be suggested for groups including similar swim lanes 400 or working on related processes. This may involve placing the user into a group of similar users. The group may be created based on user behavior such as what processes are being followed, what types of process elements are reviewed, which elements are commented on, and so forth. A socially relevant group can contain the users who are working on any processes containing components similar or related to a particular swim lane 400 of process X. According to the technology presented herein, when elements within any of those processes become hotter (more socially active), the members of the group may be notified. Also, a specific process group may be created of those members such that they can provide valuable information. A socially relevant group may be considered a dynamically generated community where users are grouped together based on their actions, attributes, and behaviors as well as by roles or specific involvement. Users may be assigned to groups based on various criteria while the users remain focused on their work within the various processes. Based on the groups assigned, lists of processes, teams, and discussions that might be relevant to the user may be detected and suggested to that user. The socially relevant groups may comprise users working on the same or similar processes. The socially relevant groups may also comprise direct first-degree co-worker connections of the primary group members. For example, if a co-worker is commenting or debating on a process step that is separate from the one that is the group's reason for existence, the system may highlight that topic for members of the group. This can facilitate knowledge dissemination by highlighting other processes that each user might wish to comment on or suggest modifications to.

Example Systems

FIG. 7 depicts a computing machine 2000 and a module 2050 in accordance with one or more embodiments presented herein. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 also may include volatile memories, such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attachment (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (“WAN”), local area networks (“LAN”), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

One or more aspects of embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of embodiments of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method for crowd sourcing business process specifications within a process discovery system, comprising:
receiving, by the process discovery system, an initial proposed process from a process owner;
publishing, by the process discovery system, the initial proposed process for access by one or more process participants;
establishing, by the process discovery system, one or more isolation layers each comprising a working copy of the initial proposed process;
associating, by the process discovery system, one of the working copies with one or more of the process participants;
receiving, by the process discovery system, social activity comprising modifications, markups, or comments to the one of the working copies from the respective associated process participants;
aggregating, by the process discovery system, multiple received modifications from the process participants;
discovering, by the process discovery system, one or more relevant social groups;
assigning, by the process discovery system, one or more process participants to one of the relevant social groups;
indicating, by the process discovery system, elements of the process associated with an increased level of social activity;
providing, by the process discovery system, notifications of process events to one or more process participants;
supporting, by the process discovery system, the process owner selectively merging process modifications from the process participants into a crowd sourced business process specification; and
informing, by the process discovery system, a development team implementing the business process with the crowd sourced business process specification.

2. The computer-implemented method of claim 1, wherein indicating elements of the process associated with an increased level of social activity comprises displaying a heat map.

3. The computer-implemented method of claim 1, wherein assigning process participants to relevant social groups comprises assignments based on expertise or interests of the process participants.

4. The computer-implemented method of claim 1, wherein assigning process participants to relevant social groups comprises establishing swim lanes based on roles associated with the process.

5. The computer-implemented method of claim 1, wherein assigning process participants to relevant social groups comprises groupings based on behaviors associated with the process participants.

6. The computer-implemented method of claim 1, wherein the notifications of process events comprise notifications associated with one of the relevant social groups.

7. The computer-implemented method of claim 1, wherein the notifications of process events comprise notifications associated with social activities.

8. The computer-implemented method of claim 1, wherein the notifications comprise various communications channels.

9. The computer-implemented method of claim 1, wherein the notifications comprise a notification cascade based on rules for a sequential notification order.

10. The computer-implemented method of claim 1, wherein the process discovery system is accessed using a client comprising a web browser.

11. A crowd-sourced process discovery system, comprising:
one or more processing units, and one or more processing modules, wherein the crowd-sourced process discovery system is configured by the one or more processing modules to:
receive an initial proposed process from a process owner;
publish the initial proposed process for access by one or more process participants;
establish one or more isolation layers each comprising a working copy of the initial proposed process;
associate one of the working copies with one or more of the process participants;
receive social activity comprising modifications, markups, or comments to the one of the working copies from the respective associated process participants;
aggregate multiple received modifications from the process participants;
discover one or more relevant social groups;
assign one or more process participants to one of the relevant social groups;
indicate elements of the process associated with an increased level of social activity;
provide notifications of process events to one or more process participants;
support the process owner selectively merging process modifications from the process participants into a crowd sourced business process specification; and
inform a development team implementing the business process with the crowd sourced business process specification.

12. The crowd-sourced process discovery system of claim 11, wherein indicating elements of the process associated with an increased level of social activity comprises displaying a heat map.

13. The crowd-sourced process discovery system of claim 11, wherein assigning process participants to relevant social groups comprises assignments based on expertise or interests of the process participants.

14. The crowd-sourced process discovery system of claim 11, wherein assigning process participants to relevant social groups comprises groupings based on behaviors associated with the process participants.

15. The crowd-sourced process discovery system of claim 11, wherein the notifications of process events comprise notifications associated with one of the relevant social groups.

16. The crowd-sourced process discovery system of claim 11, wherein the notifications of process events comprise notifications associated with social activities.

17. The crowd-sourced process discovery system of claim 11, wherein the notifications comprise various communications channels.

18. The crowd-sourced process discovery system of claim 11, wherein the notifications comprise a notification cascade based on rules for a sequential notification order.

19. The crowd-sourced process discovery system of claim 11, wherein the process discovery system is accessed using a client comprising a web browser.

20. A computer program product, comprising:
a non-transitory computer-readable storage medium having computer-readable program code embodied therein that, when executed by one or more computing devices, perform a method comprising:
receiving an initial proposed process from a process owner;
publishing the initial proposed process for access by one or more process participants;
establishing one or more isolation layers each comprising a working copy of the initial proposed process;
associating one of the working copies with one or more of the process participants;
receiving social activity comprising modifications, markups, or comments to the one of the working copies from the respective associated process participants;
aggregating multiple received modifications from the process participants;
discovering one or more relevant social groups based on behaviors of the process participants;
assigning one or more process participants to one of the relevant social groups;
rendering heat maps to indicate elements of the process associated with an increased level of social activity by rending;
providing notifications of process events to one or more process participants according to their association with the relevant social groups;
supporting selectively merging elements from the aggregated modifications into a crowd sourced business process specification; and
informing a development team implementing the business process with the crowd sourced business process specification.
